(19) United States
(12) Patent Application Publication
(10) Pub. No.: US 2014/0188371 A1
(43) Pub. Date: Jul. 3, 2014

(54) CONTROL DEVICE FOR INTERNAL COMBUSTION ENGINE

(71) Applicant: Kazuya Miyaji, Okazaki-shi (JP)

(72) Inventor: Kazuya Miyaji, Okazaki-shi (JP)

(73) Assignee: TOYOTA JIDOSHA KABUSHIKI KAISHA, Toyota-shi, Aichi-ken (JP)

(21) Appl. No.: 14/232,394

(22) PCT Filed: Sep. 13, 2011
(86) PCT No.: PCT/JP2011/070806

§ 371 Date: Jan. 13, 2014

(51) Int. Cl. F02D 41/14

(52) U.S. Cl. CPC F02D 41/1454
USPC 701/103

(57) ABSTRACT

An ECU executes a program including the steps of: when an aging completion flag is ON, determining that a predetermine value serves as an abnormality determination threshold value; when the aging completion flag is OFF, determining the abnormality determination threshold value depending on to what extent aging has progressed; and determining whether or not an air/fuel ratio sensor is abnormal using the determined threshold value.

### TECHNICAL FIELD

The present invention relates to a technology for making a highly accurate determination of whether or not an air/fuel ratio sensor provided at an exhaust path of an internal combustion engine is abnormal.

### BACKGROUND ART

For instance, as disclosed in Japanese Patent Laying-Open No. 2007-315855 (PTD 1), a technology for detecting an air/fuel ratio with an air/fuel ratio sensor and controlling an internal combustion engine such that it operates at a desired air/fuel ratio has hitherto been known.

### CITATION LIST

### Patent Document

PTD 1: Japanese Patent Laying-Open No. 2007-315855

### SUMMARY OF INVENTION

### Technical Problem

Meanwhile, in manufacturing air/fuel ratio sensors, a silicon component may be contained as an impurity in a detection element of an air/fuel ratio sensor. The silicon component will decrease in its residual amount due to the use of the air/fuel ratio sensor; however, early in the use of the air/fuel ratio sensor, the residual silicon component causes, in particular, a problem of an unstable output value of the air/fuel ratio sensor under circumstances where the atmosphere is flowing through an exhaust path. As a result, early in the use of the air/fuel ratio sensor, an erroneous determination of whether or not there is abnormality of the air/fuel ratio sensor may be made.

An object of the present invention is to provide a control device for an internal combustion engine which makes a highly accurate determination of whether or not an air/fuel ratio sensor is abnormal.

### Solution to Problem

A control device for an internal combustion engine according to an aspect of the present invention includes: an air/fuel ratio sensor which is provided at an internal combustion engine, contains a residual silicon component in a detection element, and experiences a decrease in residual amount of the silicon component due to the use; and a control unit for determining whether or not the air/fuel ratio sensor is abnormal based on a detection result by the air/fuel ratio sensor. When there is a large residual amount of the silicon component, the control unit makes the determination of abnormality less strict than when there is a small residual amount of the silicon component.

Preferably, the control unit determines that the air/fuel ratio sensor is abnormal when a condition for determining abnormality is satisfied and, when there is a large residual amount of the silicon component, makes the condition for determining abnormality less strict than when there is a small residual amount of the silicon component.

More preferably, when accumulated operating time of the internal combustion engine is short, the control unit makes the condition for determining abnormality less strict than when accumulated operating time of the internal combustion engine is long.

More preferably, when electric current passes through the air/fuel ratio sensor a small number of times, the control unit makes the condition for determining abnormality less strict than when electric current passes through the air/fuel ratio sensor a large number of times.

More preferably, when there is a large residual amount of the silicon component, the control unit estimates a second, actual amount of oxygen such that the second amount of oxygen is larger than a first amount of oxygen detected by the air/fuel ratio sensor to a large extent compared with when there is a small residual amount of the silicon component.

More preferably, when accumulated operating time of the internal combustion engine is short, the control unit estimates the second amount of oxygen such that the second amount of oxygen is larger than the first amount of oxygen to a large extent compared with when accumulated operating time of the internal combustion engine is long.

More preferably, when electric current passes through the air/fuel ratio sensor a small number of times, the control unit estimates the second amount of oxygen such that the second amount of oxygen is larger than the first amount of oxygen to a large extent compared with when electric current passes through the air/fuel ratio sensor a large number of times.

A control device for an internal combustion engine according to another aspect of the present invention includes: an air/fuel ratio sensor which is provided at an internal combustion engine and includes a detection element containing a silicon component derived from a manufacturing process; and a control unit for determining whether or not the air/fuel ratio sensor is abnormal based on a detection result by the air/fuel ratio sensor. When accumulated operating time of the internal combustion engine is short, the control unit makes a condition for determining abnormality less strict than when accumulated operating time of the internal combustion engine is short.

A control device for an internal combustion engine according to still another aspect of the present invention includes: an air/fuel ratio sensor which is provided at an internal combustion engine, contains a residual silicon component in a detection element, and experiences a decrease in residual amount of the silicon component due to the use; and a control unit which determines whether or not the residual silicon component is beyond an allowable range based on a variation range of an output value of the air/fuel ratio sensor during execution of fuel cut control over the internal combustion engine.

Preferably, the control unit determines that the air/fuel ratio sensor is abnormal when a condition for determining abnormality is satisfied based on a detection result by the air/fuel ratio sensor, and, when the variation range during execution of the fuel cut control is wide, makes the condition for determining abnormality less strict than when the variation range is narrow.

More preferably, when the variation range during execution of the fuel cut control is wide, the control unit estimates a second, actual amount of oxygen such that the second amount of oxygen is larger than a first amount of oxygen detected by the air/fuel ratio sensor to a large extent compared with when the variation range is narrow.

More preferably, the control unit determines that the air/fuel ratio sensor is abnormal when a condition for determining abnormality is satisfied based on a detection result by the air/fuel ratio sensor, and, when the variation range during execution of the fuel cut control is wide, determines whether or not the condition for determining abnormality is satisfied with a temperature of an element of the air/fuel ratio sensor increased compared with when the variation range is narrow.

More preferably, the control unit determines that the air/fuel ratio sensor is abnormal when a condition for determining abnormality is satisfied based on a detection result by the air/fuel ratio sensor, and, when the variation range during execution of the fuel cut control is wide, determines whether or not the condition for determining abnormality is satisfied with a voltage applied to an element of the air/fuel ratio sensor increased compared with when the variation range is narrow.

### Advantageous Effects of Invention

According to the present invention, when there is a large residual amount of silicon component, the determination of abnormality of an air/fuel ratio sensor is made less strict than when there is a small residual amount of silicon component. Hence, suppression of making an erroneous determination of whether or not there is abnormality of the air/fuel ratio sensor when there is a large residual amount of silicon component early in the use of the air/fuel ratio sensor is achieved. In addition, as a residual amount of silicon component gets smaller due to the use, making determination of abnormality less strict is gradually ended. Therefore, a control device for an internal combustion engine which makes a highly accurate determination of whether or not an air/fuel ratio sensor is abnormal can be provided.

### BRIEF DESCRIPTION OF DRAWINGS

FIG. 1 shows a configuration of an internal combustion engine in a first embodiment.

FIG. 2 shows a configuration of an air/fuel ratio sensor.

FIG. 3 is for illustrating a silicon component contained in the air/fuel sensor.

FIG. 4 is a timing chart showing a variation of a limit current of the air/fuel ratio sensor under the atmosphere, which is dependent on the state of progress of aging.

FIG. 5 is a functional block diagram on an aging determination process by an ECU in the first embodiment.

FIG. 6 is a flowchart showing a control structure of a program as to the aging determination process executed at the ECU in the first embodiment.

FIG. 7 is a functional block diagram on an abnormality determination process by the ECU in the first embodiment.

FIG. 8 shows the relation between atmospheric limit current and an abnormality determination threshold value, which is dependent on the state of progress of aging.

FIG. 9 is a flowchart showing a control structure of a program as to the abnormality determination process executed at the ECU in the first embodiment.

FIG. 10 is a functional block diagram on an abnormality determination process by an ECU in a second embodiment.

FIG. 11 is a flowchart showing a control structure of a program as to the abnormality determination process executed at the ECU in the second embodiment.

FIG. 12 shows the relation between the atmospheric limit current and the abnormality determination threshold value, which is dependent on the temperature of an element of the air/fuel ratio sensor.

FIG. 13 is a functional block diagram on an abnormality determination process by an ECU in a third embodiment.

FIG. 14 is a flowchart showing a control structure of a program as to the abnormality determination process executed at the ECU in the third embodiment.

FIG. 15 shows the relation between the atmospheric limit current and an applied voltage, which is dependent on the state of progress of aging.

FIG. 16 is a functional block diagram on an abnormality determination process by an ECU in a fourth embodiment.

FIG. 17 is a flowchart showing a control structure of a program as to the abnormality determination process executed at the ECU in the fourth embodiment.

### DESCRIPTION OF EMBODIMENTS

The embodiments of the present invention will be hereinafter described with reference to the drawings. In the following description, the same parts have the same reference signs allotted. They have the same names and functions. Therefore, a detailed description thereof will not be repeated.

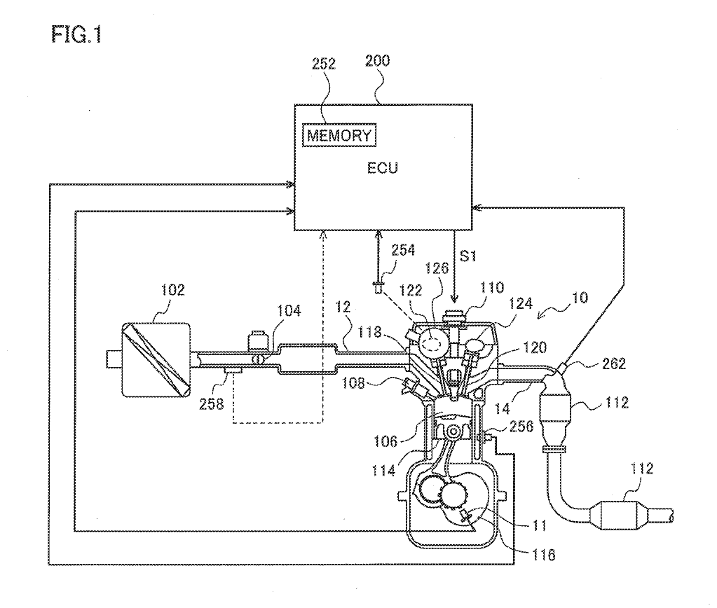

As shown in FIG. 1, in the present embodiment, an engine 10 includes an intake path 12, an exhaust path 14, an air cleaner 102, a throttle valve 104, a plurality of cylinders 106, an injector 108, a spark plug 110, a three-way catalyst 112, a piston 114, a crankshaft 116, an intake valve 118, an exhaust valve 120, an intake-side cam 122, an exhaust-side cam 124, and a VVT (Variable Valve Timing) mechanism 126.

Engine 10 in the present embodiment is an internal combustion engine such as a gasoline engine and a diesel engine.

Engine 10 takes the air in from air cleaner 102. The air taken from air cleaner 102 flows through intake path 12. The amount of intake air is regulated by throttle valve 104 provided along intake path 12. Throttle valve 104 is an electronic throttle valve driven by a motor.

Controlled by an ECU 200, injector 108 supplies fuel to each of a plurality of cylinders 106 (combustion chamber). Injector 108 has an injection hole provided in cylinders 106. Injector 108 directly injects fuel into the cylinders. In cylinder 106, the air and fuel which have flown through intake path 12 are mixed together. Injector 108 injects fuel in an intake stroke. It is noted that the timing at which fuel is injected is not limited to an intake stroke.

In the present embodiment, engine 10 is described as a direct-injection engine in which injector 108 has an injection hole provided in cylinder 106; however, in addition to injector 108 for direct injection, an injector for port injection may be provided. Further, only the injector for port injection may be provided.

The supply of fuel from injector 108 forms an air-fuel mixture in cylinder 106, which is ignited by spark plug 110 and combusts. A combusted air-fuel mixture, that is, exhaust gas flows through exhaust path 14. Exhaust gas is purified by three-way catalyst 112 provided along exhaust path 14, and subsequently discharged to the outside of a vehicle. The combustion of an air-fuel mixture depresses piston 114 and rotates crankshaft 116. When fuel cut control is executed while engine 10 is running, the fuel supply from injector 108 is stopped. At this time, the air (atmosphere) which has flown through intake path 12 flows through via cylinder 106 to exhaust path 14.

At a head of cylinder 106, intake valve 118 and exhaust valve 120 are provided. The amount and timing of the air introduced into cylinder 106 are controlled by intake valve 118. The amount and timing of the air discharged from cylinder 106 is controlled by exhaust valve 120. Intake valve 118 is driven by intake-side cam 122. Exhaust valve 120 is driven by exhaust-side cam 124.

The open/close timing (phase) of intake valve 118 is changed by VVT mechanism 126. It is noted that the open/close timing of exhaust valve 120 may be changed.

In the present embodiment, VVT mechanism 126 rotates a camshaft (not shown) on which intake-side cam 122 is provided, thereby controlling the open/close timing of intake valve 118. It is noted that a method of controlling the open/close timing is not limited to the above. In the present embodiment, VVT mechanism 126 is hydraulically actuated. VVT mechanism 126 may be provided at exhaust-side cam 124.

Engine 10 is controlled based on a control signal S1 from ECU 200. ECU 200 controls a throttle opening degree, ignition timing, fuel injection timing, an amount of fuel injection, and the open/close timing of intake valve 118 such that engine 10 is in a desired operational state. Signals from an engine rotational speed sensor 11, a cam angle sensor 254, a water temperature sensor 256, an air flow meter 258, and an air/fuel ratio sensor 262 are input into ECU 200.

Engine rotational speed sensor 11 outputs a signal indicating the rotational speed of crankshaft 116 (hereinafter referred to as engine rotational speed) NE. Cam angle sensor 254 outputs a signal indicating the position of intake-side cam 122. Water temperature sensor 256 outputs a signal indicating the temperature of cooling water for engine 10. Air flow meter 258 outputs a signal indicating an amount of the air taken into engine 10. Air/fuel ratio sensor 262 outputs a signal indicating an air/fuel ratio.

ECU 200 controls engine 10 based on these signals input from the sensors and a map and a program which are stored in a memory 252.

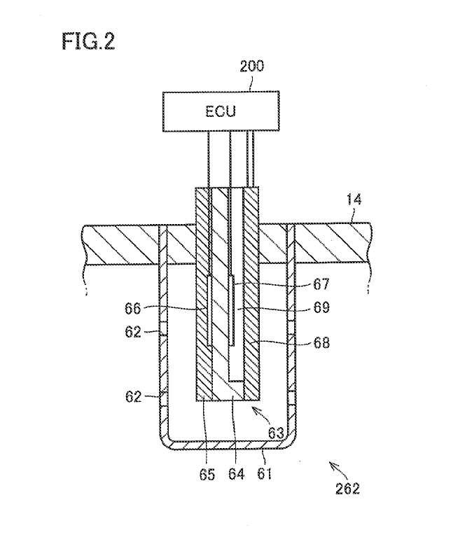

FIG. 2 shows one example of the configuration of air/fuel ratio sensor 262. Air/fuel ratio sensor 262 in the present embodiment is a laminated air/fuel ratio sensor. As shown in FIG. 2, air/fuel ratio sensor 262 is provided to protrude into the interior of exhaust path 14 of engine 10. Air/fuel ratio sensor 262 includes a cover 61 and a sensor body 63. Sensor body 63 includes a solid electrolyte layer 64, a diffusion-resistant layer 65, an exhaust-side electrode 66, an atmosphere-side electrode 67, a heater 68, and an atmosphere duct 69.

Cover 61 has a cup-shaped cross section which accommodates sensor body 63 in its interior. Cover 61 has a circumferential wall in which a number of small apertures 62 communicating the inside and outside of cover 61 into each other are formed. It is noted that a plurality of covers 61 may be provided.

In sensor body 63, plate-like solid electrolyte layer 64 has one surface onto which exhaust-side electrode 66 is fixed. On the other hand, solid electrolyte layer 64 has the other surface onto which atmosphere-side electrode 67 is fixed. On the opposite side of a surface of exhaust-side electrode 66 fixed onto solid electrolyte layer 64, diffusion-resistant layer 65 is provided. On the opposite side of a surface of atmosphere-side electrode 67 fixed onto solid electrolyte layer 64, atmosphere duct 69 is provided.

Solid electrolyte layer 64 is, in the present embodiment, a zirconia element. Exhaust-side electrode 66 and atmosphere-side electrode 67 are, for example, platinum electrodes. Diffusion-resistant layer 65 is, for example, porous ceramics.

Heater 68 is a heating element which generates heat upon passage of electric current from ECU 200 therethrough. Heater 68 is operated by duty control by ECU 200. Heater 68 heats sensor body 63 with generated heat energy and activates solid electrolyte layer 64. Heater 68 has a sufficient heat generation capacity to activate solid electrolyte layer 64.

ECU 200 controls heater 68 such that, for example, an admittance value As of solid electrolyte layer 64 is greater than or equal to a target admittance value Ast. ECU 200 starts duty control over heater 68, for example, upon the start of engine 10 such that admittance value As is greater than or equal to target admittance value Ast. ECU 200 increases a duty ratio when admittance value As is less than target admittance value Ast, and decreases a duty ratio when admittance value As is greater than or equal to target admittance value Ast.

ECU 200 detects heater current Ih which heater 68 carries. ECU 200 may directly detect heater current Ih using a sensor or the like or may estimate heater current Ih based on a control value for heater 68.

As shown in FIG. 2, atmosphere-side electrode 67 and exhaust-side electrode 66 of sensor body 63 are connected to ECU 200. ECU 200 applies a voltage for detection between atmosphere-side electrode 67 and exhaust-side electrode 66. The application of a voltage causes air/fuel ratio sensor 262 to carry electric current dependent on the concentration of oxygen in exhaust gas. ECU 200 detects electric current generated by migration of oxygen ions between atmosphere-side electrode 67 and exhaust-side electrode 66.

For instance, when exhaust gas has a lean air/fuel ratio, surplus oxygen in exhaust gas is ionized receiving an electron due to an electrode reaction at exhaust-side electrode 66. The oxygen ion migrates in the interior of solid electrolyte layer 64 from exhaust-side electrode 66 toward atmosphere-side electrode 67 and reaches atmosphere-side electrode 67 at which the electron is detached, and the oxygen ion turns back into oxygen and is then discharged into atmosphere duct 69. Such migration of oxygen ions causes electric current to flow from atmosphere-side electrode 67 toward exhaust-side electrode 66.

On the other hand, when exhaust gas has a rich air/fuel ratio, contrary to when the ratio is lean, oxygen in atmosphere duct 69 is ionized receiving an electron due to an electrode reaction at atmosphere-side electrode 67. The oxygen ion migrates in the interior of solid electrolyte layer 64 from atmosphere-side electrode 67 toward exhaust-side electrode 66, then undergoes a catalytic reaction with HC, CO, and H₂, which are unburnt components present in the interior of diffusion-resistant layer 65, and thereby produces carbon dioxide CO₂ and water H₂O. Such migration of oxygen ions causes electric current to flow from exhaust-side electrode 66 toward atmosphere-side electrode 67.

Hence, a value of electric current which air/fuel ratio sensor 262 carries and which is detected by ECU 200 (hereinafter referred to as output current value Iaf) varies depending on the concentration of oxygen in gas flowing through exhaust path 14. Hence, once the relation between output current value Iaf and an air/fuel ratio is determined by an experiment, calculations, or the like, an air/fuel ratio can be calculated based on output current value Iaf. In addition, an increase and decrease in output current value Iaf corresponds to an increase and decrease in air/fuel ratio (to what extent the ratio is lean or rich). As an air/fuel ratio gets leaner (as the concentration of oxygen increases), output current value Iaf increases. As an air/fuel ratio gets richer (as the concentration of oxygen decreases), output current value Iaf decreases.

In air/fuel ratio sensor 262 having the configuration as above, solid electrolyte layer 64 serving as a detection element may contain a silicon component such as SiO₂ as an impurity. Such a silicon component is subjected to a removal processing using acid or the like in a manufacturing process of air/fuel ratio sensor 262; however, the removal processing may not completely remove the silicon component. The silicon component will decrease in its residual amount due to the use of air/fuel ratio sensor 262. Hence, when there is a large residual amount of silicon component early in the use of air/fuel ratio sensor 262, the residual silicon component may cause unstable output current value Iaf of air/fuel ratio sensor 262. A state in which output current value Iaf is unstable may occur, in particular, under circumstances where the atmosphere is flowing through exhaust path 14. In the following description, output current value Iaf of air/fuel ratio sensor 262 under circumstances where the atmosphere is flowing through exhaust path 14 is also referred to as atmospheric limit current IL. The circumstances where the atmosphere is flowing through exhaust path 14 refer to, for example, during execution of the fuel cut control.

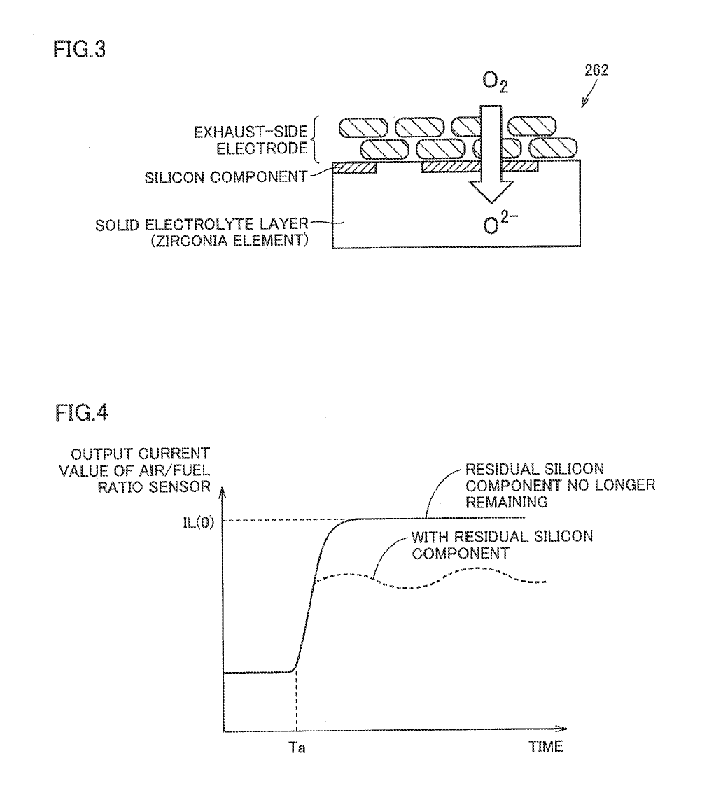

As shown in FIG. 3, for instance, when a silicon component is interposed between exhaust-side electrode 66 and solid electrolyte layer 64, the silicon component inhibits migration of an oxygen ion as oxygen ions migrate from exhaust-side electrode 66 to solid electrolyte layer 64.

In particular, when the atmosphere is flowing through exhaust path 14, there is much surplus oxygen at exhaust-side electrode 66. In such a case, the inhibition of migration of oxygen ions may unstabilize atmospheric limit current IL of air/fuel ratio sensor 262.

FIG. 4 shows a variation of output current value Iaf of air/fuel ratio sensor 262 with time. As shown in FIG. 4, at time Ta, output current value Iaf of air/fuel ratio sensor 262 increases with an increase in the concentration of oxygen after execution of the fuel cut control, and reaches atmospheric limit current IL.

A solid line in FIG. 4 shows an upward variation in output current value Iaf of air/fuel ratio sensor 262 when a residual silicon component no longer remains. A broken line in FIG. 4 shows an upward variation in output current value Iaf of air/fuel ratio sensor 262 when there is a residual silicon component.

Atmospheric limit current IL when there is a residual silicon component, which is indicated by the broken line in FIG. 4, has a lower value than that of atmospheric limit current IL when a residual silicon component no longer remains, which is indicated by a solid line in FIG. 4, and fluctuates in a manner responsive to ON/OFF of heater 68.

Atmospheric limit current IL is used for the determination of abnormality of air/fuel ratio sensor 262. Hence, when atmospheric limit current IL of air/fuel ratio sensor 262 is unstable in such a manner due to a residual silicon component, an erroneous determination of whether or not air/fuel ratio sensor 262 is abnormal may be made.

Thus, the present embodiment is characterized in that when there is a large residual amount of silicon component, ECU 200 makes the determination of abnormality less strict than when there is a small residual amount of silicon component.

Specifically, ECU 200 determines that air/fuel ratio sensor 262 is abnormal when a condition for determining abnormality, which will be described later, is satisfied. When there is a large residual amount of silicon component, ECU 200 makes the condition for determining abnormality less strict than when there is a small residual amount of silicon component.

Further, in the present embodiment, ECU 200 executes an aging determination process and thereby determines whether or not aging of air/fuel ratio sensor 262 has been completed.

A state in which “aging has been completed” corresponds to a state in which a residual amount of silicon component in air/fuel ratio sensor 262 is small, that is, within an allowable range. A state in which “aging has not been completed” corresponds to a state in which a residual amount of silicon component in air/fuel ratio sensor 262 is large, that is, beyond the allowable range.

Therefore, when aging of air/fuel ratio sensor 262 has not been completed, ECU 200 makes the condition for determining abnormality less strict than when aging of air/fuel ratio sensor 262 has been completed.

As to Aging Determination Process

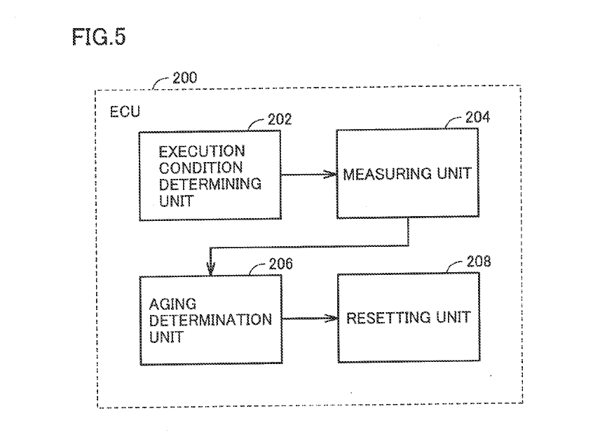

An aging determination process for air/fuel ratio sensor 262 will be described below. FIG. 5 shows a functional block diagram on the aging determination process by ECU 200 included in a control device for an internal combustion engine according to the present embodiment. ECU 200 includes an execution condition determining unit 202, a measuring unit 204, an aging determining unit 206, and a resetting unit 208.

Execution condition determining unit 202 determines whether or not a condition for executing the aging determination process is satisfied. In the present embodiment, the condition for executing the aging determination process includes a first condition that aging has not been completed, a second condition that air/fuel ratio sensor 262 is active, a third condition that the fuel cut control over engine 10 is being executed, and a fourth condition that a predetermined period of time T(0) has passed since the start of execution of the fuel cut control. Execution condition determining unit 202 determines that the condition for executing the aging determination process is satisfied when all of the first, second, third, and fourth conditions are satisfied.

Execution condition determining unit 202 determines that the first condition is satisfied when, for example, an aging completion flag, which will be described later, is OFF.

Execution condition determining unit 202 determines that the second condition is satisfied when the temperature of sensor body 63 of air/fuel ratio sensor 262 (hereinafter referred to as element temperature) Taf is greater than a threshold value Taf (0) at which the sensor becomes active.

Execution condition determining unit 202 may determine that element temperature Taf is greater than threshold value Taf(0) when, for example, admittance value As of solid electrolyte layer 64 is greater than aforementioned target admittance value Ast. Execution condition determining unit 202 calculates admittance value As of solid electrolyte layer 64 from a voltage Va applied to solid electrolyte layer 64 and output current value Iaf.

Execution condition determining unit 202 determines that the third condition is satisfied when a condition for executing the fuel cut control is satisfied and fuel injection has been stopped. The condition for executing the fuel cut control is, for example, conditions corresponding to a fuel cut at deceleration, a fuel cut at high rotation, a fuel cut at the maximum speed, and the like.

The condition corresponding to a fuel cut at deceleration includes, for example, a condition that the throttle valve is totally closed and engine rotational speed Ne is greater than or equal to a threshold value Ne(0).

The condition corresponding to a fuel cut at high rotation includes, for example, a condition that engine rotational speed Ne is greater than or equal to a threshold value Ne(1). It is noted that threshold value Ne(1) is a value greater than threshold value Ne(0). Threshold value Ne(1) is set such that engine rotational speed Ne does not exceed a predetermined upper limit value.

The condition corresponding to a fuel cut at the maximum speed includes, for example, a condition that vehicle speed V is greater than or equal to a threshold value V(0) and the duration of a state in which engine rotational speed Ne is greater than or equal to a threshold value Ne(2) exceeds a predetermined period of time T(1).

Predetermined period of time T(0) of the fourth condition is a period of time that has passed from the start of execution of the fuel cut control and allows for a determination that the concentration of oxygen in gas flowing through exhaust path 14 has converged to the concentration of oxygen in the atmosphere. Predetermined period of time T(0) is adjusted through experiments or the like.

It is noted that execution condition determining unit 202 may turn an execution condition determination flag ON when the condition for execution is satisfied, for example.

Measuring unit 204 measures the maximum value Imax and the minimum value Imin of output current value Iaf of air/fuel ratio sensor 262 when it is determined by execution condition determining unit 202 that the condition for execution is satisfied. Measuring unit 204 compares output current value Iaf of air/fuel ratio sensor 262 with each of maximum value Imax and minimum value Imin which are stored in memory 252.

Measuring unit 204 updates maximum value Imax, for example, by rewriting maximum value Imax stored in memory 252 to detected output current value Iaf when output current value Iaf is greater than maximum value Imax stored in memory 252. Measuring unit 204 updates minimum value Imin, for example, by rewriting minimum value Imin stored in memory 252 to detected output current value Iaf when output current value Iaf is less than minimum value Imin stored in memory 252.

It is noted that measuring unit 204 does not update maximum value Imax and minimum value Imin when, for example, detected output current value Iaf is not greater than maximum value Imax and not less than minimum value Imin. Measuring unit 204 measures aforementioned maximum value Imax and minimum value Imin for each predetermined calculation cycle. Measuring unit 204 measures maximum value Imax and minimum value Imin until the fuel cut control ends.

Measuring unit 204 terminates measurement of maximum value Imax and minimum value Imin when the fuel cut control ends. Measuring unit 204 may determine that the fuel cut control has ended when the aforementioned condition for executing the fuel cut control is not satisfied, or may determine that the fuel cut control has ended when fuel injection is resumed, for example.

It is noted that measuring unit 204 may measure maximum value Imax and minimum value Imin when, for example, the execution condition determination flag is ON. Measuring unit 204 may measure maximum value Imax when heater 68, which will be described later, is ON and may measure minimum value Imin when heater 68 is OFF.

Based on a result of measurement by measuring unit 204, aging determining unit 206 determines whether or not aging of air/fuel ratio sensor 262 has been completed.

Specifically, aging determining unit 206 determines whether or not aging of air/fuel ratio sensor 262 has been completed when a time period for measurement of maximum value Imax and minimum value Imin by measuring unit 204 is greater than or equal to a predetermined period of time T(2) and there is an operational history of heater 68 during measurement by measuring unit 204.

Aforementioned predetermined period of time T(2) is a time period for measurement of at least maximum value Imax and minimum value Imin and is adjusted through experiments or the like. Predetermined period of time T(2) may be, for example, a period of time including a period over which heater 68 is turned ON and a period over which heater 68 is turned OFF. This is because output current value laf fluctuates depending on ON and OFF of heater 68 when aging of air/fuel ratio sensor 262 has not been completed.

Aging determining unit 206 may determine whether or not there is an operational history of heater 68 based on, for example, the state of an operation flag of heater 68. The operation flag of heater 68 is turned ON when heater 68 operates during the time period for measurement by measuring unit 204. Aging determining unit 206 determines that there is an operational history of heater 68 when the operation flag of heater 68 is ON.

Aging determining unit 206 determines that aging of air/fuel ratio sensor 262 has been completed when maximum value Imax−minimum value Imin is less than a threshold value ΔI(0). Threshold value ΔI(0) is a value which is for determining that fluctuation of output current value Iaf has converged, that is, a residual amount of silicon component is within an allowable range, and which is adjusted through experiments or the like.

It is noted that aging determining unit 206 does not determine whether or not aging of air/fuel ratio sensor 262 has been completed when a time period for measurement of maximum value Imax and minimum value Imin by measuring unit 204 is not greater than or equal to predetermined period of time T(2) or when there is no operational history of heater 68 during measurement by measuring unit 204.

Determining that aging of air/fuel ratio sensor 262 has been completed, aging determining unit 206 turns the aging completion flag ON. Determining that aging of air/fuel ratio sensor 262 has not been completed, aging determining unit 206 turns the aging completion flag OFF.

Resetting unit 208 resets each of maximum value Imax and minimum value Imin when a predetermined condition is satisfied. The predetermined condition is that any one of the following conditions is satisfied: a condition that execution condition determining unit 202 determines that the condition for execution is not satisfied; a condition that aging determining unit 206 does not determine whether or not aging has been completed; and a condition that aging determining unit 206 determines that aging has not been completed.

It is noted that resetting unit 208 may reset each of maximum value Imax and minimum value Imin upon satisfaction of the predetermined condition that execution condition determining unit 202 determines that the condition for execution is satisfied, or prior to the start of measurement by measuring unit 204.

Resetting unit 208 resets maximum value Imax and minimum value Imin to initial values Imax(0) and Imin(0), respectively, when the aforementioned predetermined condition is satisfied. It is noted that initial values Imax(0) and Imin(0) are, for example, zero.

In the present embodiment, although execution condition determining unit 202, measuring unit 204, aging determining unit 206, and resetting unit 208 are all described as functioning as software implemented by a CPU of ECU 200 executing the program stored in memory 252, they may be implemented by hardware.

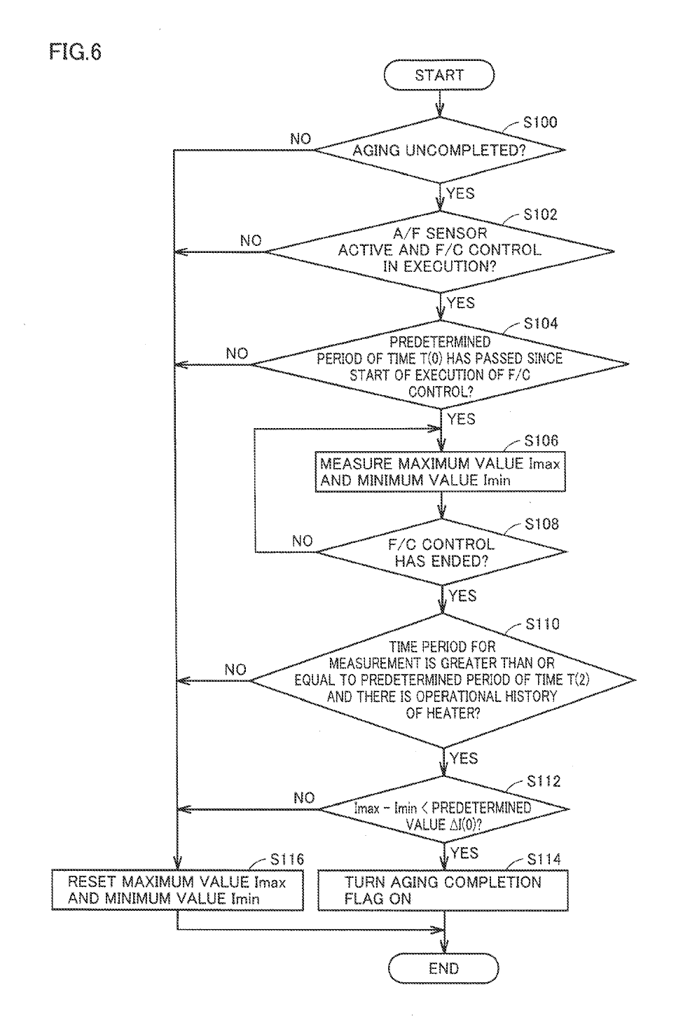

Referring to FIG. 6, a description will be given on a control structure of a program as to the aging determination process executed at ECU 200 included in the control device for an internal combustion engine according to the present embodiment.

In step (hereinafter step is referred to as S) 100, ECU 200 determines whether or not aging is uncompleted. If it is determined that aging is uncompleted (YES in S100), then the process shifts to S102. If not (NO in S100), then the process shifts to S116.

In S102, ECU 200 determines whether or not air/fuel ratio sensor 262 is active and the fuel cut control is being executed. If air/fuel ratio sensor 262 is active and the fuel cut control is being executed (YES in S102), then the process shifts to S104. If not (NO in S102), then the process shifts to S116.

In S104, ECU 200 determines whether or not predetermined period of time T(0) has passed since the start of the fuel cut control. If predetermined period of time T(0) has passed since the start of the fuel cut control (YES in S104), then the process shifts to S106. If not (NO in S104), then the process shifts to S116.

In S106, ECU 200 measures maximum value Imax and minimum value Imin of output current value I of air/fuel ratio sensor 262.

In S108, ECU 200 determines whether or not the fuel cut control has ended. If the fuel cut control has ended (YES in S108), then the process shifts to S110. If not (NO in S108), then the process returns to S106.

In S110, ECU 200 determines whether or not a time period for measurement of maximum value Imax and minimum value Imin is greater than or equal to predetermined period of time T(2) and there is an operational history of heater 68 during the time period for measurement. If the time period for measurement is longer than or equal to predetermined period of time T(2) and there is an operational history of heater 68 during the time period for measurement (YES in S110), then the process shifts to S112. If not (NO in S110), then the process shifts to S116.

In S112, ECU 200 determines whether or not maximum value Imax−minimum value Imin is less than a predetermined value ΔI(0). If maximum value Imax−minimum value Imin is less than predetermined value ΔI(0) (YES in S112), then the process shifts to S114. If not (NO in S112), then the process shifts to S116.

In S114, ECU 200 turns the aging completion flag ON. In S116, ECU 200 resets maximum value Imax and minimum value Imin to initial values Imax(0) and Imin(0), respectively.

A description will be given on an operation as to the aging determination process of ECU 200 included in the control device for an internal combustion engine according to the present embodiment, which is based on the structure and flowchart as above.

For instance, a case where aging has not been completed early in the use of air/fuel ratio sensor 262 is assumed (YES in S100).

After the start of engine 10, the operation of heater 68 causes an increase in element temperature Taf. Element temperature Taf greater than threshold value Taf(0) makes air/fuel ratio sensor 262 active. In addition, the fuel cut control over engine 10 is executed when the condition for executing the fuel cut control is satisfied while engine 10 is running.

When air/fuel ratio sensor 262 is active and the fuel cut control is executed (YES in S102), it is determined whether or not predetermined period of time T(0) has passed since the start of the fuel cut control (S104).

In a state where predetermined period of time T(0) has passed since the start of the fuel cut control (YES in S104) and where the concentration of oxygen in gas flowing through exhaust path 14 has converged, maximum value Imax and minimum value Imin are measured (S106).

When the fuel cut control has ended (YES in S108) and a time period for the measurement prior to the end of the fuel cut control is longer than predetermined period of time T(2) and there is an operational history of heater 68 during the measurement (YES in S110), whether or not aging of air/fuel ratio sensor 262 has been completed is determined. That is, whether or not maximum value Imax−minimum value Imin is less than threshold value ΔI(0) is determined (S112). When maximum value Imax−minimum value Imin is less than threshold value ΔI(0) (YES in S112), the aging completion flag is turned ON(S114). That is, it is determined that aging of air/fuel ratio sensor 262 has been completed.

It is noted that when aging has been completed (NO in S100), maximum value Imax and minimum value Imin are reset (S116). In addition, when air/fuel ratio sensor 262 is not active (NO in S102) or when the fuel cut control is not being executed (NO in S102), maximum value Imax and minimum value Imin are also reset (S116). Further, when predetermined period of time T(0) has not passed since the start of the fuel cut control (NO in S104), maximum value Imax and minimum value Imin are also reset (S116).

Further, when a time period for measurement is shorter than predetermined period of time T(2) (NO in S110) or when there is no operational history of heater 68 during the measurement (NO in S110), maximum value Imax and minimum value Imin are also reset (S116). In addition, when maximum value Imax−minimum value Imin is greater than or equal to threshold value ΔI(0) (NO in S112), maximum value Imax and minimum value Imin are also reset (S116).

As to Abnormality Determination Process for Air/Fuel Ratio Sensor

Next, a description will be given on an abnormality determination process for air/fuel ratio sensor 262 executed by ECU 200 based on a determination result of the aging determination process.

In the present embodiment, ECU 200 determines that a condition for determining abnormality is satisfied and thus air/fuel ratio sensor 262 is abnormal when atmospheric limit current IL of air/fuel ratio sensor 262 is less than a threshold value IL_th. When aging has not been completed, ECU 200 makes the condition for determining abnormality less strict than when aging has been completed.

In the present embodiment, when aging has not been completed, ECU 200 lowers aforementioned threshold value IL_th and thereby makes the condition for determining abnormality less strict than when aging has been completed.

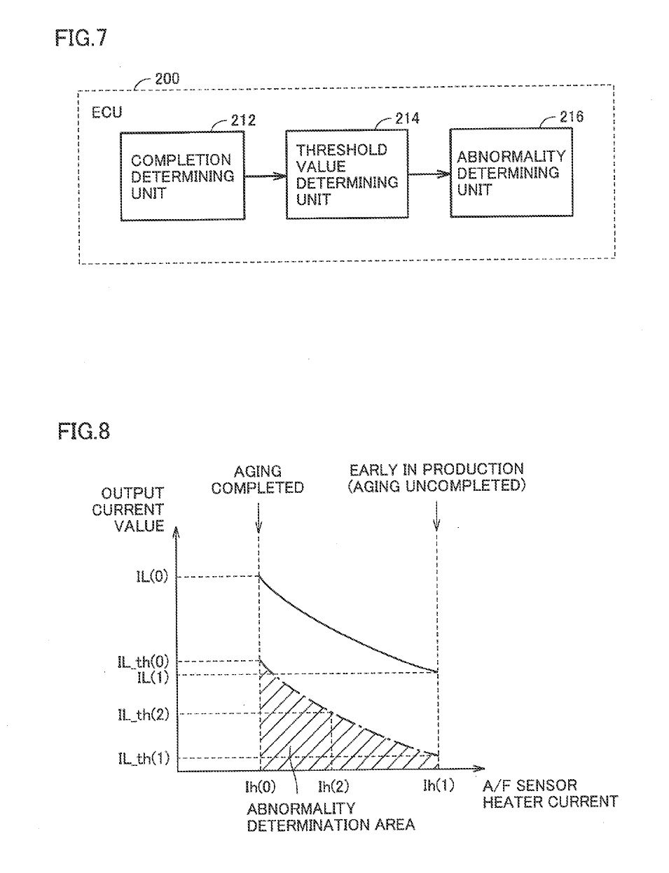

FIG. 7 shows a functional block diagram on the abnormality determination process by ECU 200 included in the control device for an internal combustion engine according to the present embodiment. ECU 200 includes a completion determining unit 212, a threshold value determining unit 214, and an abnormality determining unit 216.

Completion determining unit 212 determines whether or not aging of air/fuel ratio sensor 262 has been completed. Completion determining unit 212 determines that aging of air/fuel ratio sensor 262 has been completed when the aging completion flag is ON. Completion determining unit 212 determines that aging of air/fuel ratio sensor 262 has not been completed when the aging completion flag is OFF.

When it is determined by completion determining unit 212 that aging has been completed, threshold value determining unit 214 determines that a predetermined value IL_th(0) serves as threshold value IL_th of atmospheric limit current IL for determining whether or not there is abnormality of air/fuel ratio sensor 262.

When it is determined by completion determining unit 212 that aging has not been completed, threshold value determining unit 214 determines threshold value IL_th based on the correlativity between atmospheric limit current IL of air/fuel ratio sensor 262 and heater current Ih. That is, when the aging completion flag is OFF, threshold value determining unit 214 determines threshold value IL_th depending on heater current Ih.

Specifically, threshold value determining unit 214 determines threshold value IL_th based on heater current Ih and on the relation between heater current Ih and threshold value IL_th as shown by an alternate long and short dash line in FIG. 8. The vertical axis of FIG. 8 indicates atmospheric limit current IL of air/fuel ratio sensor 262 and threshold value IL_th. The horizontal axis of FIG. 8 indicates heater current Ih.

It is noted that heater current Ih shown in FIG. 8 indicates, for example, a local maximum value of heater current Ih during measurement of atmospheric limit current IL. It is noted that heater current Ih shown in FIG. 8 may be an average value of heater current Ih during measurement of atmospheric limit current IL or may be the maximum value of heater current Ih between the start of measurement of atmospheric limit current IL and an elapse of a predetermine period of time therefrom.

As shown in FIG. 8, atmospheric limit current IL when aging of air/fuel ratio sensor 262 has been completed is IL(0). At this time, heater current Ih is Ih(0). Threshold value IL_th is predetermined value IL_th(0). Predetermined value IL_th(0) is set with reference to, for example, atmospheric limit current IL(0). Predetermined value IL_th(0) may be calculated, for example, by subtracting a predetermined value from atmospheric limit current IL(0) or by multiplying atmospheric limit current IL(0) by a predetermined coefficient α(0) (<1).

On the other hand, atmospheric limit current IL when aging of air/fuel ratio sensor 262 has not been completed early in the production is IL(1), which is a value less than atmospheric limit current IL(0) when aging has been completed.

At this time, heater current Ih is Ih(1), which is a value greater than heater current Ih(0) when aging has been completed.

Further, threshold value IL_th is a predetermined value IL_th(1), which is a value less than threshold value IL_th(0) when aging has been completed. It is noted that predetermined value IL_th(1) is also set with reference to atmospheric limit current IL(1) in the same manner as with predetermined value IL_th(0). A detailed description thereof will not be repeated.

As shown by a solid line in FIG. 8, as aging of air/fuel ratio sensor 262 progresses (as a residual amount of silicon component decreases), atmospheric limit current IL increases above atmospheric limit current IL(1) of when aging has not been completed early in the production, while heater current Ih decreases below Ih(1). As shown by the alternate long and short dash line in FIG. 8, as aging of air/fuel ratio sensor 262 progresses, threshold value IL_th increases above IL_th(1) in a manner as shown by the alternate long and short dash line in FIG. 8.

Threshold value determining unit 214 determines, as threshold value IL_th, a value IL_th(2) which is derived from the alternate long and short dash line in FIG. 8 when heater current Ih is Ih(2), for example.

Abnormality determining unit 216 determines whether or not air/fuel ratio sensor 262 is abnormal using threshold value IL_th determined by threshold value determining unit 214. That is, abnormality determining unit 216 determines that air/fuel ratio sensor 262 is normal when atmospheric limit current IL is greater than threshold value IL_th.

Abnormality determining unit 216 determines that air/fuel ratio sensor 262 is abnormal when atmospheric limit current IL is less than or equal to threshold value IL_th. It is noted that abnormality determining unit 216 may, for example, turn an abnormality determination flag ON when it is determined that an air/fuel ratio sensor 262 is abnormal.

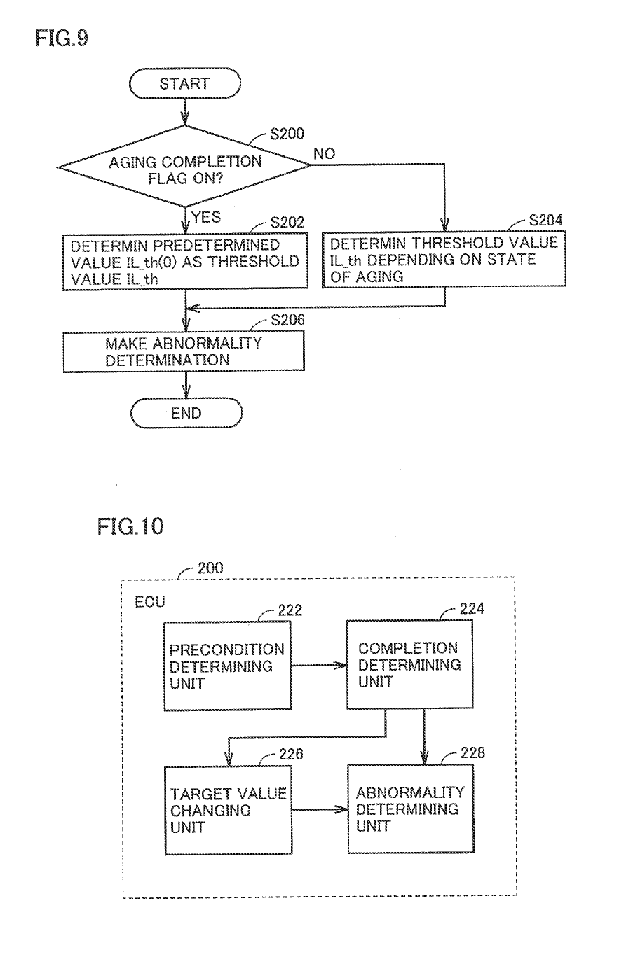

Referring to FIG. 9, a description will be given on a control structure of a program as to the abnormality determination process for air/fuel ratio sensor 262 executed at ECU 200 included in the control device for an internal combustion engine according to the present embodiment.

In S200, ECU 200 determines whether or not the aging completion flag is ON. If the aging completion flag is ON (YES in S200), then the process shifts to S202. If not (NO in S200), then the process shifts to S204.

In S202, ECU 200 determines predetermined value IL_th(0) as threshold value IL_th. In S204, ECU 200 determines threshold value IL_th depending on the state of aging of air/fuel ratio sensor 262. Specifically, ECU 200 determines threshold value IL_th from heater current Ih and from the relation between heater current Ih and threshold value IL_th shown by the alternate long and short dash line in FIG. 8. In S206, ECU 200 determines whether or not air/fuel ratio sensor 262 is abnormal.

A description will be given on an operation as to the abnormality determination process of ECU 200 included in the control device for an internal combustion engine according to the present embodiment, which is based on the structure and flowchart as above.

For instance, a case where aging has not been completed early in the use of air/fuel ratio sensor 262 is assumed. At this time, the aging completion flag is OFF (NO in S200). Hence, threshold value IL_th is determined from heater current Ih and from the relation between heater current Ih and threshold value IL_th shown by the alternate long and short dash line in FIG. 8 (S204).

Then, based on the determined threshold value IL_th, whether or not there is abnormality is determined (S206). That is, it is determined that air/fuel ratio sensor 262 is normal when atmospheric limit current IL is greater than threshold value IL_th.

It is determined that air/fuel ratio sensor 262 is abnormal when atmospheric limit current IL is less than or equal to threshold value IL_th.

It is noted that determining that air/fuel ratio sensor 262 is abnormal, ECU 200 may inform an occupant of a vehicle that air/fuel ratio sensor 262 is abnormal, for example, using a display, an alarm lamp, a sound-generating device, or the like.

As above, according to the control device for an internal combustion engine according to the present embodiment, when there is a large residual amount of silicon component, the determination of abnormality of air/fuel ratio sensor 262 is made less strict than when there is a small residual amount of silicon component. Hence, suppression of making an erroneous determination of whether or not there is abnormality of air/fuel ratio sensor 262 when there is a large residual amount of silicon component early in the use of air/fuel ratio sensor 262 is achieved. In addition, as the residual amount of silicon component gets smaller due to the use, making determination of abnormality less strict is gradually ended. Therefore, a control device for an internal combustion engine which makes a highly accurate determination of whether or not an air/fuel ratio sensor is abnormal can be provided.

In the present embodiment, ECU 200 has been described as, but is not particularly limited to, one that calculates, in the aging determination process, a variation range from a difference between maximum value Imax and minimum value Imin of output current value Iaf and determines that aging has been completed when the calculated variation range is less than predetermined value ΔI(0).

For instance, ECU 200 may determine in the aging determination process that aging has been completed when accumulated operating time of engine 10 is longer than or equal to a predetermined period of time. In the abnormality determination process, when accumulated operating time of engine 10 is short, ECU 200 may make the condition for determining abnormality less strict than when accumulated operating time of engine 10 is long. For instance, in the abnormality determination process, when accumulated operating time of engine 10 is longer than or equal to a predetermined period of time, ECU 200 may employ predetermined value IL_th(0) as threshold value IL_th to determine whether or not there is an abnormality of air/fuel ratio sensor 262. When accumulated operating time of engine 10 is shorter than a predetermined period of time, ECU 200 may determine threshold value IL_th such that it is less than IL_th(0) to a large extent compared with when accumulated operating time is long. ECU 200 may determine threshold value IL_th in proportion to the accumulated operating time.

Alternatively, ECU 200 may determine in the aging determination process that aging has been completed when the number of times that electric current passes through air/fuel ratio sensor 262 is greater than or equal to a predetermined number of times. Further, in the abnormality determination process, when electric current passes through air/fuel ratio sensor 262 a small number of times, ECU 200 may make the condition for determining abnormality less strict than when electric current passes through air/fuel ratio sensor 262 a large number of times. For instance, in the abnormality determination process, when the number of times that electric current passes through air/fuel ratio sensor 262 is greater than or equal to a predetermined number of times, ECU 200 may employ predetermined value IL_th(0) as threshold value IL_th to determine whether or not there is abnormality of air/fuel ratio sensor 262. When the number of times that electric current passes through air/fuel ratio sensor 262 is less than a predetermined number of times, ECU 200 may determine threshold value IL_th such that it is less than IL_th(0) to a large extent compared with when electric current passes through air/fuel ratio sensor 262 a large number of times. ECU 200 may determine threshold value IL_th in proportion to the number of times that electric current passes through air/fuel ratio sensor 262.

In the present embodiment, although ECU 200 determines whether or not air/fuel ratio sensor 262 is active based on admittance value As of air/fuel ratio sensor 262, the determination may be made using an impedance value Is, for example. For instance, ECU 200 may determine that air/fuel ratio sensor 262 is active when impedance value Is is less than a predetermined value Is(0).

In the present embodiment, air/fuel ratio sensor 262 may have any configuration in which an exhaust-side electrode and a solid electrolyte layer containing a silicon component as an impurity are laminated, and is not particularly limited to have the configuration of laminated air/fuel ratio sensor 262 which includes a plate-like exhaust-side electrode and a plate-like solid electrolyte layer as shown in FIG. 2. For instance, air/fuel ratio sensor 262 may have a configuration including a test-tube-like solid electrolyte layer, exhaust-side electrode, and atmosphere-side electrode.

In the present embodiment, ECU 200 makes a highly accurate determination of whether or not an air/fuel ratio sensor is abnormal, by performing an abnormality determination method for air/fuel ratio sensor 262 including the steps of: when there is a large residual amount of silicon component, making the determination of abnormality less strict than when there is small residual amount of silicon component; and determining whether or not air/fuel ratio sensor 262 is abnormal based on a result of detection by air/fuel ratio sensor 262.

### Second Embodiment

A control device for an internal combustion engine according to a second embodiment will be described below. ECU 200 in the control device for an internal combustion engine according to the present embodiment differs in an operation of ECU 200 compared with the configuration of ECU 200 in the control device for an internal combustion engine according to the above-described first embodiment. The rest is the same in configuration as the control device for an internal combustion engine according to the above-described first embodiment. They have the same reference signs allotted. They also have the same functions. Therefore, a detailed description thereof will not be repeated here.

In the present embodiment, ECU 200 is characterized in that when a variation range (maximum value Imax−minimum value Imin) of output current value Iaf of air/fuel ratio sensor 262 during execution of the fuel cut control is wide, ECU 200 determines whether or not there is abnormality with element temperature Taf of air/fuel ratio sensor 262 increased compared with when the variation range is narrow.

FIG. 10 shows a functional block diagram on the abnormality determination process by ECU 200 included in the control device for an internal combustion engine according to the present embodiment. ECU 200 includes a precondition determining unit 222, a completion determining unit 224, a target value changing unit 226, and an abnormality determining unit 228.

Precondition determining unit 222 determines whether or not a precondition for executing the determination of abnormality of air/fuel ratio sensor 262 is satisfied. The precondition is a condition that allows for the estimation that atmospheric limit current IL is stable. The precondition includes, for example, a condition that the fuel cut control is being executed, a condition that predetermined period of time T(0) has passed since the start of the fuel cut control, a condition that air/fuel ratio sensor 262 is active, a condition that a predetermined period of time T(3) has passed since an EGR valve provided at engine 10 is closed, and a condition that no determination of abnormality has been made on the present trip. It is noted that precondition determining unit 222 may turn a precondition determination flag ON when the precondition is satisfied. A trip refers to a period between IG ON and IG OFF.

Completion determining unit 224 determines whether or not aging of air/fuel ratio sensor 262 has been completed. Completion determining unit 224 determines that aging has been completed when the aging completion flag is ON. Completion determining unit 224 determines that aging has not been completed when the aging completion flag is OFF.

It is noted that the state of the aging completion flag is changed based on a result of the aging determination process. The aging determination process is as described in the above-described first embodiment, and therefore, a detailed description thereof will not be repeated.

When aging of air/fuel ratio sensor 262 has not been completed, target value changing unit 226 increases target admittance value Ast above an initial value Ast(0). Initial value Ast(0) is an admittance value which allows element temperature Taf to be within a temperature range corresponding to an active state, provided that aging has been completed. Target value changing unit 226 determines target admittance value Ast by adding an amount of increase ΔAst to initial value Ast(0). Amount of increase ΔAst may be a predetermined value. Alternatively, amount of increase ΔAst may be an amount of increase dependent on to what extent aging has progressed. For instance, target value changing unit 226 may determine amount of increase ΔAst such that when aging has progressed to a great extent (when aging has been nearly completed), amount of increase ΔAst is smaller than when aging has progressed to a little extent. It is noted that target value changing unit 226 may, for example, calculate to what extent aging has progressed based on a value of maximum value Imax−minimum value Imin.

It is noted that target value changing unit 226 may, for example, increase applied voltage Va when the precondition determination flag is ON and the aging completion flag is OFF.

Abnormality determining unit 228 determines whether or not air/fuel ratio sensor 262 is abnormal using threshold value IL_th of atmospheric limit current IL. That is, abnormality determining unit 228 determines that air/fuel ratio sensor 262 is normal when atmospheric limit current IL is greater than threshold value IL_th.

Abnormality determining unit 228 determines that air/fuel ratio sensor 262 is abnormal when atmospheric limit current IL is less than or equal to threshold value IL_th. It is noted that abnormality determining unit 228 may, for example, turn the abnormality determination flag ON when it is determined that air/fuel ratio sensor 262 is abnormal.

Referring to FIG. 11, a description will be given on a control structure of a program as to the abnormality determination process for air/fuel ratio sensor 262 executed at ECU 200 included in the control device for an internal combustion engine according to the present embodiment.

In S300, ECU 200 determines whether or not the precondition is satisfied. The precondition is as described above, and therefore, a detailed description thereof will not be repeated. If the precondition is satisfied (YES in S300), then the process shifts to S302. If not (NO in S300), the process ends.

In S302, ECU 200 determines whether or not the aging completion flag is ON. If the aging completion flag is ON (YES in S302), then the process shifts to S306. If not (NO in S302), then the process shifts to S304.

In S304, ECU 200 changes target admittance value Ast. Details of a change in target admittance value Ast are as described above, and therefore, a detailed description thereof will not be repeated. In S306, ECU 200 determines whether or not air/fuel ratio sensor 262 is abnormal.

A description will be given on an operation as to the abnormality determination process of ECU 200 included in the control device for an internal combustion engine according to the present embodiment, which is based on the structure and flowchart as above. It is noted that the operation as to the aging determination process of ECU 200 is as described in the above-described first embodiment, and therefore, a detailed description thereof will not be repeated.

For instance, a case where aging has not been completed early in the use of air/fuel ratio sensor 262 is assumed. At this time, the aging completion flag is OFF.

It is determined that the precondition is satisfied (YES in S300) when predetermined period of time T(0) has passed since the fuel cut control was started responsive to a traveling state of a vehicle, air/fuel ratio sensor 262 becomes active, predetermined period of time T(3) has passed since the EGR valve was closed, and no determination of abnormality has been made after IG ON.

Because the aging completion flag is OFF (NO in S302), target admittance value Ast is changed (S304). Hence, element temperature Taf of air/fuel ratio sensor 262 increases.

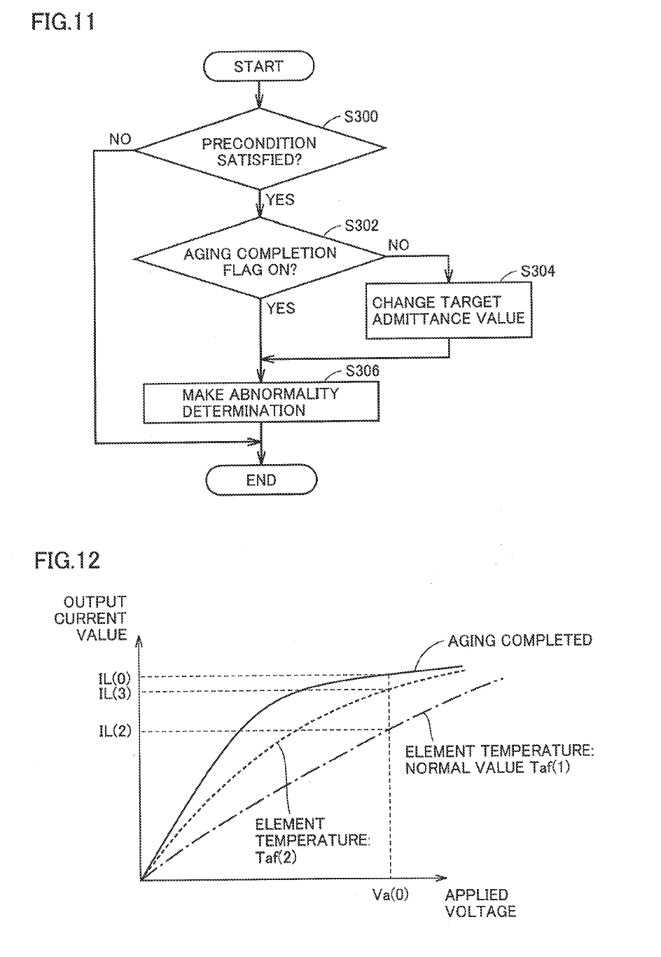

FIG. 12 shows the relation between output current value Iaf and applied voltage Va, which is dependent on element temperature Taf. The horizontal axis of FIG. 12 indicates applied voltage Va, while the vertical axis of FIG. 12 indicates output current value Iaf.

A solid line in FIG. 12 shows the relation between atmospheric limit current IL and applied voltage Va when aging of air/fuel ratio sensor 262 has been completed and element temperature Taf has a normal value Taf(1). ECU 200 controls heater 68 such that element temperature Taf converges to normal value Taf(1) which is within a temperature range corresponding to an active state. In this case, when applied voltage Va is Va(0), the value of atmospheric limit current IL is IL(0).

An alternate long and short dash line in FIG. 12 shows the relation between atmospheric limit current IL and applied voltage Va when aging of air/fuel ratio sensor 262 has not been completed and element temperature Taf has normal value Taf(1). In this case, when applied voltage Va is Va(0), the value of atmospheric limit current IL is IL(2).

An increase in target admittance value Ast when aging has not been completed causes ECU 200 to control heater 68 such that element temperature Taf converges to temperature Taf(2) which is higher than normal value Taf(1). This results in that atmospheric limit current IL and applied voltage Va have a relation as shown by a broken line in FIG. 12. In this case, as shown by the broken line in FIG. 12, when applied voltage Va is Va(0), the value of atmospheric limit current IL is IL(3). IL(3) is a value greater than IL(2). That is, an increase in target admittance value Ast enables bringing the value of atmospheric limit current IL close to IL(0) which is the value of atmospheric limit current IL when aging has been completed. Hence, suppression of erroneous determinations is achieved in determining whether or not there is abnormality (S306).

When the aging completion flag is ON (YES in S302), whether or not there is abnormality is determined (S306) without changing target admittance value Ast. That is, it is determined that air/fuel ratio sensor 262 is normal when atmospheric limit current IL is greater than threshold value IL_th. It is determined that air/fuel ratio sensor 262 is abnormal when atmospheric limit current IL is less than or equal to threshold value IL_th.

It is noted that determining that air/fuel ratio sensor 262 is abnormal, ECU 200 may inform a driver to that effect using a sound, a display, an alarm lamp, or the like.

As above, when a variation range of output current value Iaf of air/fuel ratio sensor 262 during execution of the fuel cut control is wide, the control device for an internal combustion engine according to the present embodiment determines whether or not the condition for determining abnormality is satisfied with element temperature Taf of air/fuel ratio sensor 262 increased compared with when the variation range is narrow. An increase in element temperature Taf of air/fuel ratio sensor 262 enables bringing the value of atmospheric limit current IL of air/fuel ratio sensor 262 when aging has not been completed close to the value of atmospheric limit current IL of air/fuel ratio sensor 262 when aging has been completed. Hence, suppression of making an erroneous determination of whether or not there is abnormality of air/fuel ratio sensor 262 when there is a large residual amount of silicon component early in the use of air/fuel ratio sensor 262 is achieved. Therefore, a control device for an internal combustion engine which makes a highly accurate determination of whether or not an air/fuel ratio sensor is abnormal can be provided.

### Third Embodiment

A control device for an internal combustion engine according to a third embodiment will be described below. ECU 200 in the control device for an internal combustion engine according to the present embodiment differs in an operation of ECU 200 compared with the configuration of ECU 200 in the control device for an internal combustion engine according to the above-described first embodiment. The rest is the same in configuration as the control device for an internal combustion engine according to the above-described first embodiment. They have the same reference signs allotted. They also have the same functions. Therefore, a detailed description thereof will not be repeated here.

In the present embodiment, ECU 200 is characterized in that when a variation range (maximum value Imax−minimum value Imin) of output current value Iaf of air/fuel ratio sensor 262 during execution of the fuel cut control is wide, ECU 200 determines whether or not there is abnormality with applied voltage Va, which is applied to solid electrolyte layer 64 serving as a detection element of air/fuel ratio sensor 262, increased compared with when the variation range is narrow.

FIG. 13 shows a functional block diagram on the abnormality determination process by ECU 200 included in the control device for an internal combustion engine according to the present embodiment. ECU 200 includes precondition determining unit 222, completion determining unit 224, a boost controlling unit 236, and abnormality determining unit 228.

It is noted that precondition determining unit 222, completion determining unit 224, and abnormality determining unit 228 are the same as precondition determining unit 222, completion determining unit 224, and abnormality determining unit 228 in the functional block diagram of ECU 200 shown in FIG. 10 described in the above-described second embodiment in their functions and operations. Therefore, a detailed description thereof will not be repeated.

When aging of air/fuel ratio sensor 262 has not been completed, boost controlling unit 236 increases applied voltage Va above an initial value Va(0). Initial value Va(0) is a voltage which allows element temperature Taf to be within a temperature range corresponding to an active state when target admittance value Ast is initial value Ast(0), provided that aging has been completed. Boost controlling unit 236 determines applied voltage Va by adding an amount of increase ΔVa to initial value Va(0). Amount of increase ΔVa may be a predetermined value. Alternatively, amount of increase ΔVa may be an amount of increase depending on to what extent aging has progressed. It is noted that a method of determining amount of increase ΔVa depending on to what extent aging has progressed is the same as the method of determining amount of increase ΔAst in the above-described second embodiment. Therefore, a detailed description thereof will not be repeated.

Boost controlling unit 236 may increase applied voltage Va by switching an internal switch to select a circuit which outputs a voltage higher than initial value Va(0). Alternatively, boost controlling unit 236 may increase applied voltage Va by controlling a boost circuit which boosts applied voltage Va linearly or stepwise.

It is noted that boost controlling unit 236 may increase applied voltage Va when, for example, the precondition determination flag is ON and the aging completion flag is OFF.

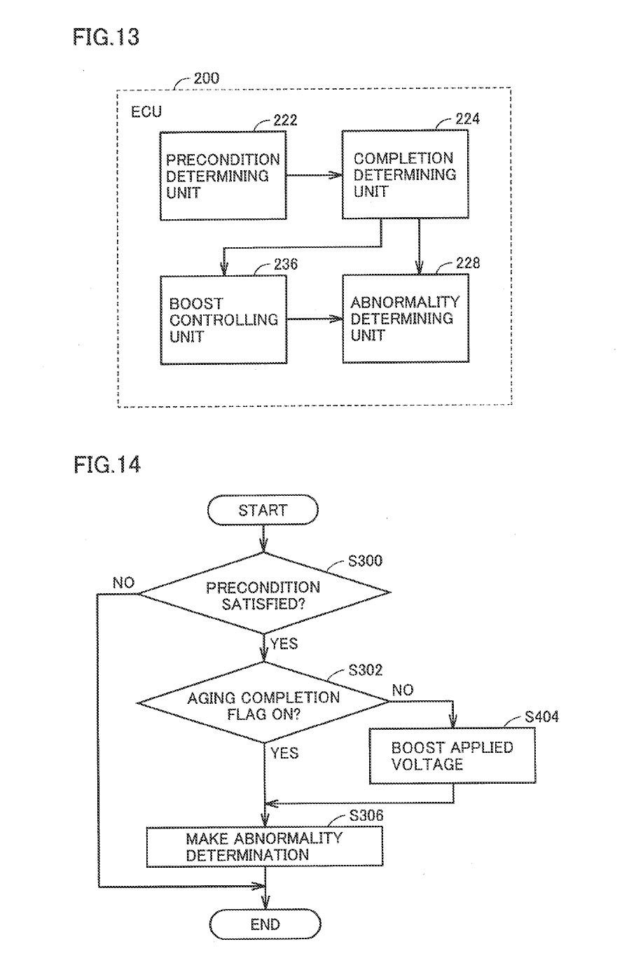

Referring to FIG. 14, a description will be given on a control structure of a program as to the abnormality determination process for air/fuel ratio sensor 262 executed at ECU 200 included in the control device for an internal combustion engine according to the present embodiment.

It is noted that in a flow chart shown in FIG. 14, the same processes as those in the aforementioned flowchart shown in FIG. 12 have the same step numbers allotted. They have the same processing as to them. Therefore, a detailed description thereof will not be repeated here.

If the aging completion flag is OFF (NO in S302), then in S404, ECU 200 increases applied voltage Va. It is noted that details of an increase in applied voltage are as described above, and therefore, a detailed description thereof will not be repeated.

A description will be given on an operation as to the abnormality determination process of ECU 200 included in the control device for an internal combustion engine according to the present embodiment, which is based on the structure and flowchart as above. It is noted that the operation as to the aging determination process of ECU 200 is as described in the aforementioned first embodiment, and therefore, a detailed description thereof will not be repeated.

For instance, a case where aging has not been completed early in the use of air/fuel ratio sensor 262 is assumed. At this time, the aging completion flag is OFF.

It is determined that the precondition is satisfied (YES in S300) when predetermined period of time T(0) has passed since the fuel cut control was started responsive to a traveling state of a vehicle, air/fuel ratio sensor 262 becomes active, predetermined period of time T(3) has passed since the EGR valve was closed, and no determination of abnormality has been made after IG ON.

Because the aging completion flag is OFF (NO in S302), applied voltage Va is increased from Va(0) to V(1) (S404).

FIG. 15 shows the relation between atmospheric limit current IL and applied voltage Va, which is dependent on whether or not aging has been completed. The horizontal axis of FIG. 15 indicates applied voltage Va, while the vertical axis of FIG. 15 indicates atmospheric limit current IL.

A solid line in FIG. 15 shows the relation between atmospheric limit current IL and applied voltage Va when aging of air/fuel ratio sensor 262 has been completed. In this case, when applied voltage Va is Va(0), the value of atmospheric limit current IL is IL(0).

A broken line in FIG. 15 shows the relation between atmospheric limit current IL and applied voltage Va when aging of air/fuel ratio sensor 262 has not been completed. In this case, when applied voltage Va is Va(0), the value of atmospheric limit current IL is IL(2).

An increase in applied voltage Va from Va(0) to Va(1) when aging has not been completed causes the value of atmospheric limit current IL to increase from IL(2) to IL(4). As a result, the value of atmospheric limit current IL when aging has not been completed can be brought close to atmospheric limit current IL(0) when aging has been completed. Hence, suppression of erroneous determinations is achieved in determining whether or not there is abnormality (S306).

When the aging completion flag is ON (YES in S302), whether or not there is abnormality is determined (S306) without increasing applied voltage Va. That is, it is determined that air/fuel ratio sensor 262 is normal when atmospheric limit current IL is greater than threshold value IL_th. It is determined that air/fuel ratio sensor 262 is abnormal when atmospheric limit current IL is less than or equal to threshold value IL_th.

It is noted that determining that air/fuel ratio sensor 262 is abnormal, ECU 200 may inform a driver to that effect using a sound, a display, an alarm lamp, or the like.

As above, when a variation range of output current value Iaf of air/fuel ratio sensor 262 during execution of the fuel cut control is wide, the control device for an internal combustion engine according to the present embodiment determines whether or not the condition for determining abnormality is satisfied with applied voltage Va of air/fuel ratio sensor 262 increased compared with when the variation range is narrow. An increase in element temperature Taf of air/fuel ratio sensor 262 enables bringing the value of atmospheric limit current IL of air/fuel ratio sensor 262 when aging has not been completed close to the value of atmospheric limit current IL of air/fuel ratio sensor 262 when aging has been completed. Hence, suppression of making an erroneous determination of whether or not there is abnormality of air/fuel ratio sensor 262 when there is a large residual amount of silicon component early in the use of air/fuel ratio sensor 262 is achieved. Therefore, a control device for an internal combustion engine which makes a highly accurate determination of whether or not an air/fuel ratio sensor is abnormal can be provided.

### Fourth Embodiment

A control device for an internal combustion engine according to a fourth embodiment will be described below. ECU 200 in the control device for an internal combustion engine according to the present embodiment differs in an operation of ECU 200 compared with the configuration of ECU 200 in the control device for an internal combustion engine according to the above-described first embodiment. The rest is the same in configuration as the control device for an internal combustion engine according to the above-described first embodiment. They have the same reference signs allotted. They also have the same functions. Therefore, a detailed description thereof will not be repeated here.

In the present embodiment, ECU 200 is characterized in that when there is a large residual amount of silicon component, ECU 200 estimates a second, actual amount of oxygen such that it is larger than a first amount of oxygen detected by air/fuel ratio sensor 262 to a large extent compared with when there is small residual amount of silicon component.

More specifically, when a variation range (maximum value Imax−minimum value Imin) of output current value Iaf of air/fuel ratio sensor 262 during execution of the fuel cut control is wide, ECU 200 estimates the second, actual amount of oxygen such that it is larger than the first amount of oxygen detected by air/fuel ratio sensor 262 to a large extent compared with when the variation range is narrow.

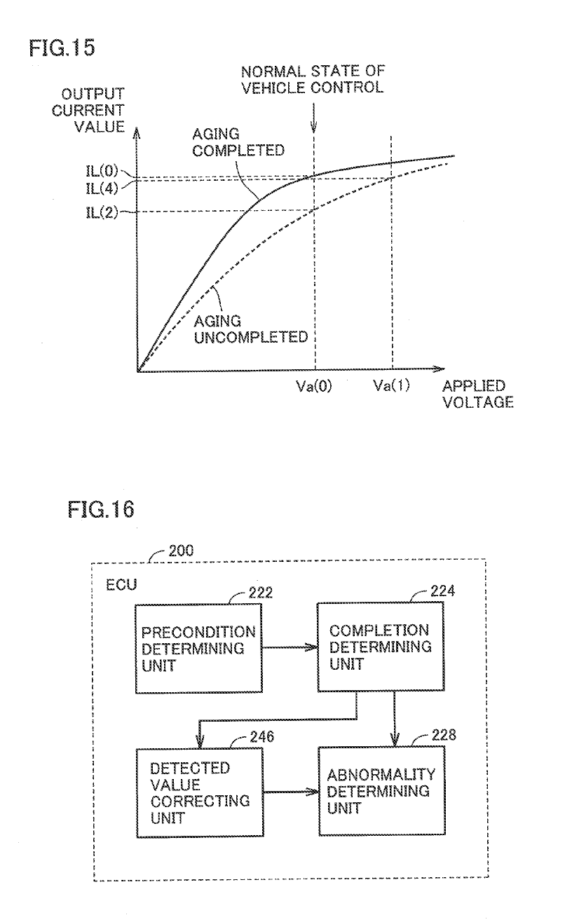

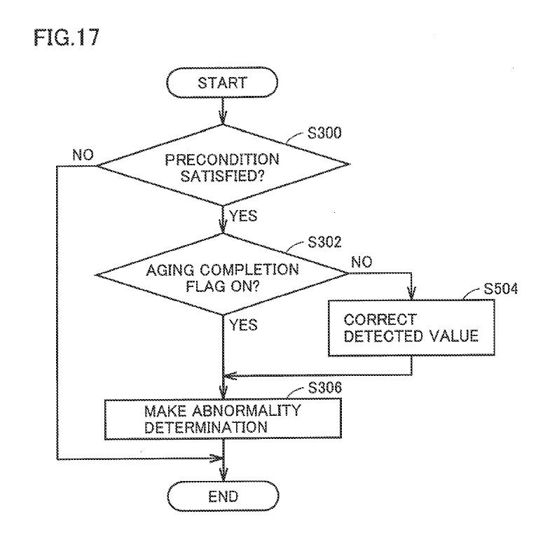

FIG. 16 shows a functional block diagram on the abnormality determination process by ECU 200 included in the control device for an internal combustion engine according to the present embodiment. ECU 200 includes precondition determining unit 222, completion determining unit 224, a detected value correcting unit 246, and abnormality determining unit 228.

It is noted that precondition determining unit 222, completion determining unit 224, and abnormality determining unit 228 are the same as precondition determining unit 222, completion determining unit 224, and abnormality determining unit 228 in the functional block diagram of ECU 200 shown in FIG. 10 described in the above-described second embodiment in their functions and operations. Therefore, a detailed description thereof will not be repeated.

When aging of air/fuel ratio sensor 262 has not been completed, detected value correcting unit 246 corrects output current value Iaf which is a value detected by air/fuel ratio sensor 262. That is, detected value correcting unit 246 calculates, as output current value Iaf, a value obtained by adding a correction value ΔIaf to a detected value Iaf(0).

Correction value ΔIaf may be a predetermined amount. Alternatively, correction value ΔIaf may be a correction amount dependent on to what extent aging has progressed. It is noted that a method of determining a correction amount dependent on to what extent aging has progressed is the same as the method of determining amount of increase ΔAst in the above-described second embodiment. Therefore, a detailed description thereof will not be repeated.

It is noted that detected value correcting unit 246 may correct a value detected by air/fuel ratio sensor 262 when, for example, the precondition determination flag is ON and the aging completion flag is OFF.

Referring to FIG. 17, a description will be given on a control structure of a program as to the abnormality determination process for air/fuel ratio sensor 262 executed at ECU 200 included in the control device for an internal combustion engine according to the present embodiment.

It is noted that in a flow chart shown in FIG. 17, the same processes as those in the aforementioned flowchart shown in FIG. 12 have the same step numbers allotted. They have the same processing as to them. Therefore, a detailed description thereof will not be repeated here.

If the aging completion flag is OFF (NO in S302), then in S504, ECU 200 corrects a value detected by air/fuel ratio sensor 262 to calculate output current value Iaf. It is noted that details of the correction are as described above, and therefore, a detailed description thereof will not be repeated.

A description will be given on an operation as to the abnormality determination process of ECU 200 included in the control device for an internal combustion engine according to the present embodiment, which is based on the structure and flowchart as above. It is noted that the operation as to the aging determination process of ECU 200 is as described in the aforementioned first embodiment, and therefore, a detailed description thereof will not be repeated.

For instance, a case where aging has not been completed early in the use of air/fuel ratio sensor 262 is assumed. At this time, the aging completion flag is OFF.

It is determined that the precondition is satisfied (YES in S300) when predetermined period of time T(0) has passed since the fuel cut control was started responsive to a traveling state of a vehicle, air/fuel ratio sensor 262 becomes active, predetermined period of time T(3) has passed since the EGR valve was closed, and no determination of abnormality has been made after IG ON.

Because the aging completion flag is OFF (NO in S302), a value detected by air/fuel ratio sensor 262 is corrected (S504). That is, output current value Iaf of air/fuel ratio sensor 262 is corrected to a value obtained by adding correction amount ΔIaf to detected value Iaf(0). Based on corrected output current value Iaf of air/fuel ratio sensor 262, whether or not there is abnormality is determined (S306). As a result, suppression of making an erroneous determination of whether or not there is abnormality of air/fuel ratio sensor 262 is achieved.

When the aging completion flag is ON(NO in S304), whether or not there is abnormality is determined (S306) without correcting output current value Iaf which is a value detected by air/fuel ratio sensor 262.

That is, it is determined that air/fuel ratio sensor 262 is normal when atmospheric limit current IL is greater than threshold value IL_th. It is determined that air/fuel ratio sensor 262 is abnormal when atmospheric limit current IL is less than or equal to threshold value IL_th.

It is noted that determining that air/fuel ratio sensor 262 is abnormal, ECU 200 may inform a driver to that effect using a sound, a display, an alarm lamp, or the like.

As above, when there is a large residual amount of silicon component, the control device for an internal combustion engine according to the present embodiment estimates the second, actual amount of oxygen such that it is larger than the first amount of oxygen detected by air/fuel ratio sensor 262 to a large extent compared with when there is small residual amount of silicon component. Hence, suppression of making an erroneous determination of whether or not there is abnormality of air/fuel ratio sensor 262 when there is a large residual amount of silicon component early in the use of air/fuel ratio sensor 262 is achieved. Therefore, a control device for an internal combustion engine which makes a highly accurate determination of whether or not an air/fuel ratio sensor is abnormal can be provided.

In addition, ECU 200 may determine in the aging determination process that aging has been completed when accumulated operating time of engine 10 is longer than or equal to a predetermined period of time. In the abnormality determination process, when accumulated operating time of engine 10 is short, ECU 200 may estimate the second, actual amount of oxygen such that it is larger than the first amount of oxygen detected by air/fuel ratio sensor 262 to a large extent compared with when the accumulated operating time is long. For instance, in the abnormality determination process, when accumulated operating time of engine 10 is longer than or equal to a predetermined period of time, ECU 200 may determine whether or not there is abnormality of air/fuel ratio sensor 262 using a value detected by air/fuel ratio sensor 262. When accumulated operating time of engine 10 is shorter than a predetermined period of time, ECU 200 may estimate the second, actual amount of oxygen such that it is larger than the first amount of oxygen detected by air/fuel ratio sensor 262 to a large extent compared with when the accumulated operating time is long, and then determine whether or not there is abnormality of air/fuel ratio sensor 262 using the second, estimated amount of oxygen. That is, ECU 200 may determine whether or not there is abnormality using a value obtained by adding a correction amount dependent on the state of aging to a value detected by air/fuel ratio sensor 262.

Alternatively, ECU 200 may determine in the aging determination process that aging has been completed when the number of times that electric current passes through air/fuel ratio sensor 262 is greater than or equal to a predetermined number of times. In the abnormality determination process, when electric current passes through air/fuel ratio sensor 262 a small number of times, ECU 200 may estimate the second, actual amount of oxygen such that it is larger than the first amount of oxygen detected by air/fuel ratio sensor 262 to a large extent compared with when electric current passes through air/fuel ratio sensor 262 a large number of times. For instance, in the abnormality determination process, when the number of times that electric current passes through air/fuel ratio sensor 262 is greater than or equal to a predetermined number of times, ECU 200 may determine whether or not there is abnormality of air/fuel ratio sensor 262 using a value detected by air/fuel ratio sensor 262. When the number of times that electric current passes through air/fuel ratio sensor 262 is less than a predetermined number of times, ECU 200 may estimate the second, actual amount of oxygen such that it is larger than the first amount of oxygen detected by air/fuel ratio sensor 262 to a large extent compared with when electric current passes through air/fuel ratio sensor 262 a large number of times, and then determine whether or not there is abnormality of air/fuel ratio sensor 262 using the second, estimated amount of oxygen. That is, ECU 200 may determine whether or not there is abnormality using a value obtained by adding a correction amount dependent on the state of aging to a value detected by air/fuel ratio sensor 262.

It should be understood that the embodiments disclosed herein are illustrative and non-restrictive in every respect. The scope of the present invention is defined by the terms of the claims rather than the above description, and is intended to include any modifications within the scope and meaning equivalent to the terms of the claims.

### REFERENCE SIGNS LIST

10 engine; 11 engine rotational speed sensor; 12 intake path; 14 exhaust path; 61 cover; 62 small aperture; 63 sensor body; 64 solid electrolyte layer; 65 diffusion-resistant layer; 66 exhaust-side electrode; 67 atmosphere-side electrode; 68 heater; 69 atmosphere duct; 102 air cleaner; 104 throttle valve; 106 cylinder; 108 injector; 110 spark plug; 112 three-way catalyst; 114 piston; 116 crankshaft; 118 intake valve; 120 exhaust valve; 122 intake-side cam; 124 exhaust-side cam; 126 VVT mechanism; 200 ECU; 202 execution condition determining unit; 204 measuring unit; 206 aging determining unit; 208 resetting unit; 212, 224 completion determining unit; 214 threshold value determining unit; 216, 228 abnormality determining unit; 222 precondition determining unit; 226 target value changing unit; 236 boost controlling unit; 246 detected value correcting unit; 252 memory; 254 cam angle sensor; 256 water temperature sensor; 258 air flow meter; 262 air/fuel ratio sensor.

1. A control device for an internal combustion engine, comprising:
an air/fuel ratio sensor provided at an internal combustion engine, containing a residual silicon component in a detection element, and experiencing a decrease in residual amount of said silicon component due to the use; and
a control unit for determining whether or not said air/fuel ratio sensor is abnormal based on a detection result by said air/fuel ratio sensor,
when there is a large residual amount of said silicon component, said control unit making the determination of abnormality less strict than when there is a small residual amount of said silicon component.

2. The control device for an internal combustion engine according to claim 1, wherein
said control unit determines that said air/fuel ratio sensor is abnormal when a condition for determining abnormality is satisfied and, when there is a large residual amount of said silicon component, makes said condition for determining abnormality less strict than when there is a small residual amount of said silicon component.

3. The control device for an internal combustion engine according to claim 2, wherein
when accumulated operating time of said internal combustion engine is short, said control unit makes said condition for determining abnormality less strict than when accumulated operating time of said internal combustion engine is long.

4. The control device for an internal combustion engine according to claim 2, wherein
when electric current passes through said air/fuel ratio sensor a small number of times, said control unit makes said condition for determining abnormality less strict than when electric current passes through said air/fuel ratio sensor a large number of times.

5. The control device for an internal combustion engine according to claim 1, wherein
when there is a large residual amount of said silicon component, said control unit estimates a second, actual amount of oxygen such that said second amount of oxygen is larger than a first amount of oxygen detected by said air/fuel ratio sensor to a large extent compared with when there is a small residual amount of said silicon component.

6. The control device for an internal combustion engine according to claim 5, wherein
when accumulated operating time of said internal combustion engine is short, said control unit estimates said second amount of oxygen such that said second amount of oxygen is larger than said first amount of oxygen to a large extent compared with when accumulated operating time of said internal combustion engine is long.

7. The control device for an internal combustion engine according to claim 5, wherein
when electric current passes through said air/fuel ratio sensor a small number of times, said control unit estimates said second amount of oxygen such that said second amount of oxygen is larger than said first amount of oxygen to a large extent compared with when electric current passes through said air/fuel ratio sensor a large number of times.

8. A control device for an internal combustion engine, comprising:
an air/fuel ratio sensor provided at an internal combustion engine and including a detection element containing a silicon component derived from a manufacturing process; and
a control unit for determining whether or not said air/fuel ratio sensor is abnormal based on a detection result by said air/fuel ratio sensor,
when accumulated operating time of said internal combustion engine is short, said control unit making a condition for determining abnormality less strict than when accumulated operating time of said internal combustion engine is short.

9. A control device for an internal combustion engine, comprising:
an air/fuel ratio sensor provided at an internal combustion engine, containing a residual silicon component in a detection element, and experiencing a decrease in residual amount of said silicon component due to the use; and
a control unit determining whether or not said residual silicon component is beyond an allowable range based on a variation range of an output value of said air/fuel ratio sensor during execution of fuel cut control over said internal combustion engine.

10. The control device for an internal combustion engine according to claim 9, wherein
said control unit determines that said air/fuel ratio sensor is abnormal when a condition for determining abnormality is satisfied based on a detection result by said air/fuel ratio sensor, and, when said variation range during execution of said fuel cut control is wide, makes said condition for determining abnormality less strict than when said variation range is narrow.

11. The control device for an internal combustion engine according to claim 9, wherein
when said variation range during execution of said fuel cut control is wide, said control unit estimates a second, actual amount of oxygen such that said second amount of oxygen is larger than a first amount of oxygen detected by said air/fuel ratio sensor to a large extent compared with when said variation range is narrow.

12. The control device for an internal combustion engine according to claim 9, wherein
said control unit determines that said air/fuel ratio sensor is abnormal when a condition for determining abnormality is satisfied based on a detection result by said air/fuel ratio sensor, and, when said variation range during execution of said the fuel cut control is wide, determines whether or not said condition for determining abnormality is satisfied with a temperature of an element of said air/fuel ratio sensor increased compared with when said variation range is narrow.

13. The control device for an internal combustion engine according to claim 9, wherein
said control unit determines that said air/fuel ratio sensor is abnormal when a condition for determining abnormality is satisfied based on a detection result by said air/fuel ratio sensor, and, when said variation range during execution of said the fuel cut control is wide, determines whether or not said condition for determining abnormality is satisfied with a voltage applied to an element of said air/fuel ratio sensor increased compared with when said variation range is narrow.
